(19) United States
(12) Patent Application Publication
(10) Pub. No.: US 2020/0228440 A1
(43) Pub. Date: Jul. 16, 2020

(54) INFORMATION PROCESSING METHOD AND RELATED DEVICE

(71) Applicant: HUAWEI TECHNOLOGIES CO., LTD., Shenzhen (CN)

(72) Inventor: Wenqi LIAO, Shenzhen (CN)

(21) Appl. No.: 16/830,809

(22) Filed: Mar. 26, 2020

Related U.S. Application Data
(63) Continuation of application No. PCT/CN2018/117719, filed on Nov. 27, 2018.

(30) Foreign Application Priority Data
Sep. 27, 2017 (CN) 201710902473.4

(51) Int. Cl. H04L 12/761; H04L 12/931; H04L 12/721; H04L 12/715; H04L 12/24; H04L 12/46

(52) U.S. Cl. CPC H04L 45/16; H04L 49/201; H04L 12/4641; H04L 45/64; H04L 41/12; H04L 45/38

(57) ABSTRACT

An information processing method and a related device. according to the method, a network controller receives a VM event (VMe) from a management server (MS), where the VMe is used to instruct the network controller to enable a secondary VM (SVM) to access a network side of SDN, and the VMe includes the SVM's identifier and an operating status of the SVM; the network controller determines the SVM as a target VM (TVM) based on the VMe; determiners based on the VMe, a target TOR switch corresponding to the TVM; the network controller generates instruction information when an operating status of the TVM is a secondary operating state, where the instruction information includes the TVM's identifier, and the instruction information is used to instruct the target TOR switch not to forward a BUM data packet to the TVM; and sends the instruction information to the target TOR switch.

### CROSS-REFERENCE TO RELATED APPLICATIONS

This application is a continuation application of PCT/CN2018/117719 dated Nov. 27, 2018, which claims priority to Chinese Patent Application No. 201710902473.4, filed on Sep. 27, 2017. The disclosures of the aforementioned applications are hereby incorporated by reference in their entireties.

### TECHNICAL FIELD

This application relates to the communications field, and in particular, to an information processing method and a related device.

### BACKGROUND

A virtual machine (VM) is a computer system that is simulated by using software, that has a complete hardware system function, and that runs in a completely isolated environment. Various physical resources on a physical host such as a processor or a memory are abstracted by using a virtualization technology, to virtualize one physical host into a plurality of logical hosts. The plurality of logical hosts are applied to a relatively wide environment, such as program development and office management.

In software-defined networking (SDN), to ensure that a specific VM works stably, an active-active access mechanism is used. To be specific, on a computing side of the SDN, a management server creates another VM corresponding to the specific VM. The VM may be referred to as a secondary VM, and correspondingly, the specific VM may be referred to as a primary VM. The primary VM and the secondary VM are synchronized due to virtual hardware and I/O input, and therefore have same data and are in a same status. The secondary VM is controlled by the management server to receive a same instruction and make a same response as the primary VM.

However, a response result of the secondary VM is shielded by the management server and is not exchanged with a network side of the SDN, and a response result of the primary VM is output externally and is exchanged with the network side of the SDN. In this scenario, when the primary VM is faulty, the management server can quickly update the original secondary VM to a new primary VM, to take over work of the original primary VM, maintain an original network connection, continue to run a related application, and maintain related service uninterrupted. Subsequently, to protect the new primary VM, the management server further creates a new secondary VM, to constitute an active-active access protection mechanism again. For perception of an external user, running of the protected specific VM has never been interrupted.

A top of rack (TOR) switch corresponding to the secondary VM is deployed on the network side of the SDN, and the TOR switch enables an interface between the TOR switch and the secondary VM to implement a connection between the secondary VM and the network side of the SDN. However, there is a broadcast, unknown unicast, or multicast (BUM) data packet in a virtual extensible local area network (VXLAN) of the network side. In a working process of the secondary VM, usually, a BUM data packet arrives at the TOR switch, to be forwarded to the secondary VM.

### SUMMARY

This application provides an information processing method and a related device, to instruct a TOR switch corresponding to a secondary VM not to forward a BUM data packet to the secondary VM, thereby properly allocating network bandwidth.

According to a first aspect, this application provides an information processing method, and the method is applied to a network controller. The method includes the following steps: The network controller receives a virtual machine (VM) event sent by a management server. The network controller is disposed in software-defined networking (SDN), and the network controller is configured to manage a network side of the SDN; a secondary VM is a VM created by the management server for a primary VM; the management server is configured to manage a computing side of the SDN; the primary VM and the secondary VM are controlled by the management server, a working response result of the primary VM is externally exchanged with the network side of the SDN, and a working response result of the secondary VM is shielded by the management server and is not exchanged with the network side of the SDN; the secondary VM is configured to take over work of the primary VM when the primary VM is faulty; and the VM event is used to instruct the network controller to enable the secondary VM to access the network side of the SDN, and the VM event includes configuration information of the secondary VM, a VM identifier of the secondary VM, and an operating status of the secondary VM. The network controller may find, based on the configuration information of the secondary VM in the VM event, the secondary VM corresponding to the VM event, and determine the secondary VM as a target VM. In addition, the network controller may further find, on the network side of the SDN based on the configuration information of the secondary VM in the VM event, a TOR switch corresponding to the target VM, and determine the TOR switch as a target TOR switch. When the network controller detects that the operating status in the VM event is a secondary operating state, the network controller is triggered to generate instruction information. The instruction information includes a VM identifier of the target VM, namely, the VM identifier of the secondary VM, and the instruction information may be used to instruct the target TOR switch not to forward a broadcast, unknown unicast, or multicast BUM data packet to the target VM. Subsequently, the network controller may send the generated instruction information to the target TOR switch.

When the management server instructs the network controller to enable the target VM to access the network side of the SDN, the network controller sends the instruction information to the target TOR switch corresponding to the target VM, to instruct the target TOR switch to perform traffic optimization and not to forward a BUM data packet to the target VM, so that the BUM data packet can be diverted to another VM, for example, the primary VM. Therefore, network bandwidth required for forwarding the BUM data packet to the target VM can be saved, thereby properly allocating network bandwidth, and avoiding a waste of network resources.

With reference to the first aspect of this application, in a possible implementation of the first aspect of this application, the network controller may directly send the instruction information to the target TOR switch, or may include the instruction information to information related to the target VM that is to be sent to the target TOR switch. Specifically, for example, the network controller may include the instruction information to a forwarding traffic access control list (ACL) corresponding to the target VM. In this case, the network controller can complete sending of the instruction information only by sending the ACL to the target TOR switch. The instruction information is included in the ACL, so that an existing signaling message is directly used, to prevent signaling interaction between the network controller and the target TOR switch from being more complicated, and further information is processed more conveniently.

Corresponding to the first aspect of this application, according to a second aspect, this application provides a network controller. From a perspective of a function module, the network controller includes a receiving unit, a first determining unit, a second determining unit, a generation unit, and a sending unit. The receiving unit is configured to receive a VM event sent by a management server. The network controller is disposed in software-defined networking SDN, and the network controller is configured to manage a network side of the SDN. A secondary VM is a VM created by the management server for a primary VM. The management server is configured to manage a computing side of the SDN. A working response result of the primary VM is exchanged with the network side of the SDN, and a working response result of the secondary VM is shielded by the management server and is not exchanged with the network side of the SDN. The secondary VM is configured to take over work of the primary VM when the primary VM is faulty. The VM event is used to instruct the network controller to enable the secondary VM to access the network side of the SDN, and the VM event includes a VM identifier of the secondary VM and an operating status of the secondary VM. The first determining unit is configured to determine the secondary VM as a target VM based on the VM event. The second determining unit is configured to determine a target top of rack TOR switch corresponding to the target VM. The target TOR switch is disposed on the network side of the SDN. The generation unit is configured to generate instruction information when the network controller detects that the operating status is a secondary operating state. The instruction information includes a VM identifier of the target VM, and the instruction information is used to instruct the target TOR switch not to forward a broadcast, unknown unicast, or multicast BUM data packet to the target VM. The sending unit is configured to send the instruction information to the target TOR switch.

With reference to the second aspect of this application, in a possible implementation of the second aspect of this application, the sending unit of the network controller may be further specifically configured to send a forwarding traffic access control list ACL to the target TOR switch. The ACL corresponds to the target VM, and the ACL includes the instruction information.

According to a third aspect, this application further provides another information processing method, and the method is applied to a top of rack TOR switch. Specifically, the TOR switch receives instruction information sent by a network controller. The instruction information includes a VM identifier of a target virtual machine VM, and the instruction information is used to instruct the TOR switch not to forward a broadcast, unknown unicast, or multicast BUM data packet to the target VM. The TOR switch corresponds to the target virtual machine VM. The target VM is a secondary VM created by a management server for a primary VM. The network controller, the TOR switch, and the management server are all disposed in software-defined networking SDN, the management server is configured to manage a computing side of the SDN, and the network controller is configured to manage a network side of the SDN. A working response result of the primary VM is exchanged with the network side of the SDN, and a working response result of the secondary VM is shielded by the management server and is not exchanged with the network side of the SDN. The secondary VM is configured to take over work of the primary VM when the primary VM is faulty. When receiving a BUM data packet, the TOR switch does not forward the BUM data packet to the corresponding target VM according to the instruction information.

The TOR switch corresponding to the target VM receives the instruction information sent by the network controller, and when receiving the BUM data packet, according to the instruction information, the TOR switch performs traffic optimization and does not forward the BUM data packet to the target VM, so that the BUM data packet can be diverted to another VM, for example, the primary VM. Therefore, network bandwidth required for forwarding the BUM data packet to the target VM can be saved, thereby properly allocating network bandwidth, and avoiding a waste of network resources.

With reference to the third aspect of this application, in a possible implementation of the third aspect of this application, the network controller may directly send the instruction information to the TOR switch, or may include the instruction information to information related to the target VM that is to be sent to the

TOR switch. Specifically, for example, the network controller may include the instruction information to a forwarding traffic access control list ACL corresponding to the target VM. In this case, the network controller can complete sending of the instruction information only by sending the ACL to the TOR switch.

The instruction information is included in the ACL, so that an existing signaling message is directly used, to prevent signaling interaction between the network controller and the TOR switch from being more complicated, and further information is processed more conveniently.

Correspondingly, after receiving the ACL corresponding to the target VM, the TOR switch may generate an outgoing interface list OIF based on the ACL. The

OIF also corresponds to the target VM, and the OIF includes the instruction information included in the ACL.

Subsequently, when receiving the BUM data packet, the TOR switch may not forward the BUM data packet to the target VM when detecting that a destination address of the BUM data packet includes an address of the target VM in the OIF and detecting that the OIF includes the instruction information.

The ACL and the OIF are set, so that a more specific application manner is provided for implementation of the information processing method. This is more practical and is convenient for application and popularization.

Corresponding to the third aspect of this application, according to a fourth aspect, this application provides a top of rack TOR switch. From a perspective of a function module, the TOR switch includes a receiving unit and a forwarding unit. The receiving unit is configured to receive instruction information sent by a network controller. The instruction information includes a VM identifier of a target virtual machine VM, and the instruction information is used to instruct the TOR switch not to forward a broadcast, unknown unicast, or multicast BUM data packet to the target VM. The TOR switch corresponds to the target virtual machine VM. The target VM is a secondary VM created by a management server for a primary VM. The network controller, the TOR switch, and the management server are all disposed in software-defined networking SDN, the management server is configured to manage a computing side of the SDN, and the network controller is configured to manage a network side of the SDN. A working response result of the primary VM is exchanged with the network side of the SDN, and a working response result of the secondary VM is shielded by the management server and is not exchanged with the network side of the SDN. The secondary VM is configured to take over work of the primary VM when the primary VM is faulty.

The forwarding unit is configured to skip forwarding a BUM data packet to the target VM according to the instruction information when the BUM data packet is received.

With reference to the fourth aspect of this application, in a possible implementation of the fourth aspect of this application, the receiving unit is specifically configured to receive a forwarding traffic access control list ACL sent by the network controller. The ACL corresponds to the target VM, and the ACL includes the instruction information.

Correspondingly, the TOR switch includes a generation unit. The generation unit is configured to generate an outgoing interface list OIF based on the ACL. The OIF corresponds to the target VM, and the OIF includes the instruction information. The forwarding unit is specifically configured to skip forwarding the BUM data packet to the target VM when the TOR switch receives the BUM data packet, the TOR switch detects that a destination address of the BUM data packet includes an address of the target VM in the OIF, and the OIF includes the instruction information.

According to a fifth aspect, this application provides an information processing system. The information processing system includes a management server, a network controller, and a top of rack TOR switch. The management server, the network controller, and the target TOR switch are all disposed in software-defined networking SDN. The management server is configured to manage a computing side of the SDN, and the network controller is configured to manage a network side of the SDN.

The management server is configured to send a virtual machine VM event to the network controller. The VM event is used to instruct the network controller to enable a secondary VM to access the network side of the SDN. The secondary VM corresponds to the TOR switch, and the secondary VM is a VM created by the management server for a primary VM. A working response result of the primary VM is exchanged with the network side of the SDN, and a working response result of the secondary VM is shielded by the management server and is not exchanged with the network side of the SDN. The secondary VM is configured to take over work of the primary VM when the primary VM is faulty. The VM event includes configuration information of the secondary VM, a VM identifier of the secondary VM, and an operating status of the secondary VM.

The network controller is configured to: find, based on the configuration information of the secondary VM in the VM event, the secondary VM corresponding to the VM event, and determine the secondary VM as a target VM. The network controller is configured to: find, on the network side of the SDN based on the configuration information of the secondary VM in the VM event, a TOR switch corresponding to the target VM, and determine the TOR switch as the target TOR switch. The network controller is configured to generate instruction information when the network controller detects that the operating status is a secondary operating state, where the instruction information includes a VM identifier of the target VM, and the instruction information is used to instruct the target TOR switch not to forward a broadcast, unknown unicast, or multicast BUM data packet to the target VM. The network controller may be configured to directly send the instruction information to the target TOR switch, or may be configured to include the instruction information to information related to the target VM that is to be sent to the target TOR switch. Specifically, for example, the network controller may be configured to include the instruction information to a forwarding traffic access control list ACL corresponding to the target VM. In this case, the network controller can complete sending of the instruction information only by sending the ACL to the target TOR switch.

The target TOR switch is configured to skip forwarding a BUM data packet to the target VM according to the instruction information when receiving the BUM data packet.

When the management server instructs the network controller to enable the target VM to access the network side of the SDN, the network controller sends the instruction information to the target TOR switch corresponding to the target VM, to instruct the target TOR switch to perform traffic optimization and not to forward a BUM data packet to the target VM, so that the BUM data packet can be diverted to another VM, for example, the primary VM. Therefore, network bandwidth required for forwarding the BUM data packet to the target VM can be saved, thereby properly allocating network bandwidth, and avoiding a waste of network resources.

According to a sixth aspect, this application provides a computer-readable storage medium. The computer-readable storage medium includes an instruction, and when the instruction runs on a network controller, the network controller is enabled to perform the method according to the first aspect or the possible implementation of the first aspect of this application.

According to a seventh aspect, this application provides a computer-readable storage medium. The computer-readable storage medium includes an instruction, and when the instruction runs on a TOR switch, the TOR switch is enabled to perform the method according to the third aspect or the possible implementation of the third aspect of this application.

According to an eighth aspect, this application provides a computer program product. The computer program product includes a computer software instruction, and when the computer software instruction runs on a network controller, the network controller is enabled to perform the method according to the first aspect or the possible implementation of the first aspect of this application.

According to a ninth aspect, this application provides a computer program product. The computer program product includes a computer software instruction, and when the computer software instruction runs on a TOR switch, the TOR switch is enabled to perform the method according to the third aspect or the possible implementation of the third aspect of this application.

### BRIEF DESCRIPTION OF DRAWINGS

FIG. 1 is a schematic application diagram of SDN according to an embodiment of this application;

FIG. 2 is a schematic application diagram of SDN in which a primary VM and a secondary VM are used according to an embodiment of this application;

FIG. 3 is a schematic structural diagram of composition of a virtualization platform according to an embodiment of this application;

FIG. 4 is a schematic diagram of data packet forwarding on an SDN forwarding plane in the related art;

FIG. 5 is a schematic diagram of data packet forwarding on an SDN forwarding plane according to an embodiment of this application;

FIG. 6 is a schematic flowchart of an information processing method according to an embodiment of this application;

FIG. 7 is a schematic structural diagram of a network controller according to an embodiment of this application;

FIG. 8 is a schematic structural diagram of a TOR switch according to an embodiment of this application;

FIG. 9 is a schematic structural diagram of another TOR switch according to an embodiment of this application;

FIG. 10 is a schematic structural diagram of an information processing system according to an embodiment of this application;

FIG. 11 is a schematic structural diagram of another network controller according to an embodiment of this application;

FIG. 12 is a schematic structural diagram of another TOR switch according to an embodiment of this application; and

FIG. 13 is a schematic structural diagram of a management server according to an embodiment of this application.

### DETAILED DESCRIPTION OF EMBODIMENTS

Embodiments of this application provide an information processing method and a related device, to instruct a TOR switch corresponding to a secondary

VM not to forward a data packet to the secondary VM, thereby properly allocating network bandwidth.

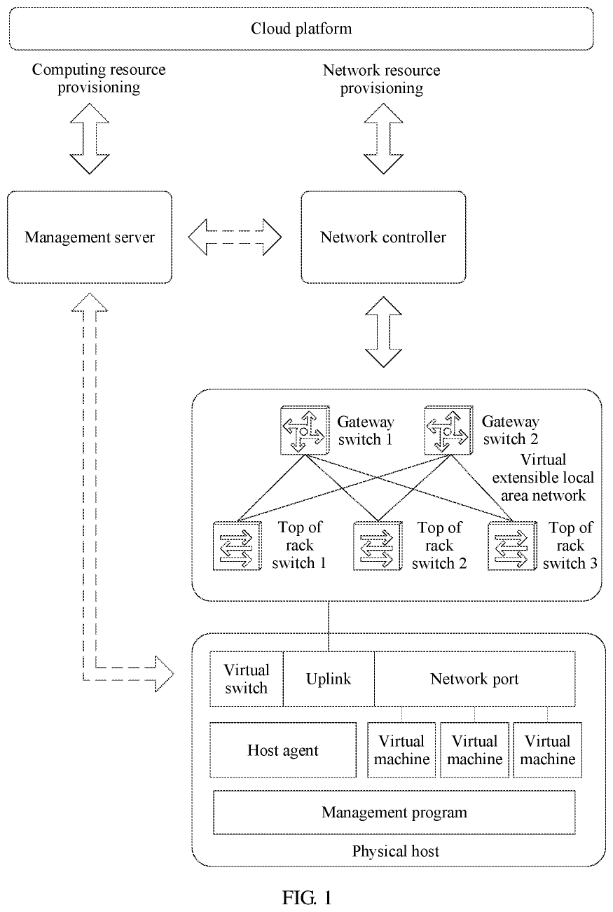

For ease of understanding the embodiments of this application, FIG. 1 is a schematic application diagram of SDN in the embodiments of this application. In some related arts, existing SDN is divided into two parts: a computing side and a network side.

The computing side includes a management server, configured to manage the computing side, for example, create a primary VM on a physical host, and create a corresponding secondary VM for the primary VM by using an active-active access mechanism. Staff such as a computing administrator may provision a computing resource on a cloud platform side by using a resource provisioning interface of the management server, for example, enable a VM on a physical host to be online, offline, or migrated, and bind the VM to a corresponding virtual local area network.

The network side includes a network controller, configured to manage the network side. For example, a control plane function of a TOR switch on the network side is centrally managed by the network controller, and the TOR switch only needs to forward a data packet and the like according to an instruction delivered by the network controller. Staff such as a network administrator may provision a network resource, namely, a logical service network, on the cloud platform side by using a network provisioning interface of the network controller.

The management server may interact with the network controller in a working process. For example, the management server may notify the network controller of an online or offline location dynamic item related to a VM and configuration information related to the VM, and the network controller performs access configuration related to the VM based on the location dynamic item, for example, delivers interface configuration information and a data packet forwarding policy that are corresponding to the VM to a TOR switch.

The management server usually centrally manages the computing side by using a software platform of a management center, to facilitate an operation of staff such as a computing administrator. In an embodiment, the software platform may be specifically a software product such as a virtual center (VMware vCenter server, vCenter) launched by VMware Information Technology Co., Ltd. (VMware), and the network controller may be specifically a device product such as an agile controller launched by Huawei Technologies Co., Ltd. Certainly, the software platform and the network controller in the embodiments of this application may be alternatively other specific products. This is not specifically limited herein.

vCenter and a vCenter-related virtualization platform product and application launched by VMware are used as examples. vCenter may be located on a separate physical host, in other words, the management server may be a separate physical host. Alternatively, vCenter may exist, in a form of a virtual machine, on a physical host such as a VMware EXS host or a VMware EXSi host. In this case, the physical host such as the VMware ESX host or the VMware ESXi host on which vCenter is disposed may be considered as the management server.

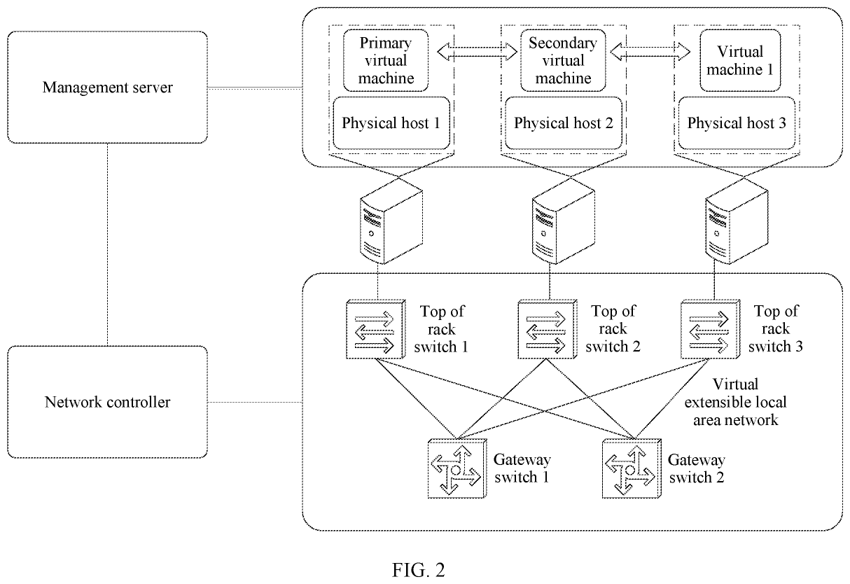

FIG. 2 is a schematic application diagram of SDN in which a primary VM and a secondary VM are used according to an embodiment of this application. For a working principle of an active-active access mechanism in the SDN, refer to the foregoing description. Details are not described herein again.

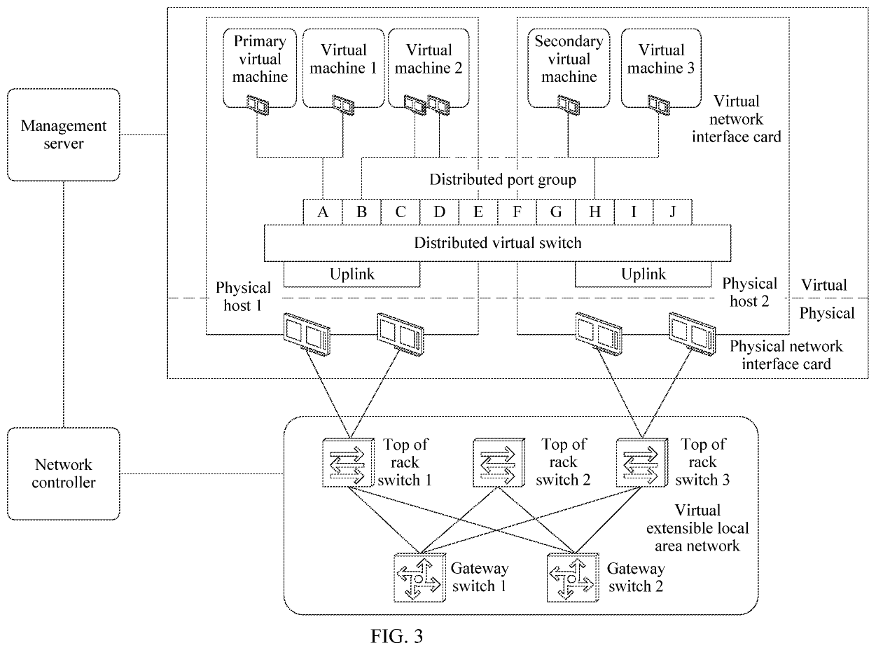

Specifically, FIG. 3 is a schematic structural diagram of a virtualization platform according to an embodiment of this application. The virtualization platform includes a plurality of physical hosts. The plurality of physical hosts are interconnected by using an Ethernet, and the plurality of physical hosts are connected to a management server. A plurality of VMs including a primary VM and a secondary VM may be deployed on the physical hosts. A corresponding virtual network interface card is disposed for each VM. The VM is connected to a virtual switch by using the virtual network interface card, and the VM may send or receive a data packet by using the virtual switch. The virtual switch may be a standard virtual switch or a distributed virtual switch, and by using a physical network interface card on the physical hosts, the virtual switch may forward a data packet to an external physical network or receive a data packet that needs to be forwarded.

The primary VM and the secondary VM are usually disposed on different physical hosts. Such disposition can avoid a case in which both the primary VM and the secondary VM are faulty because one physical host is faulty. In this case, as shown in FIG. 3, a distributed virtual switch is deployed between a physical host 1 on which the primary VM is located and a physical host 2 on which the secondary VM is located, and a related data packet may be directly sent or received between the primary VM and the secondary VM by using the distributed virtual switch.

When the original primary VM is faulty or staff actively update the primary VM and the secondary VM, the original secondary VM may be updated to a new primary VM, and the original primary VM may be deleted or updated to a new secondary VM. Alternatively, as shown in FIG. 2, a VM 1 in other VMs may be updated to a new secondary VM. Still alternatively, a new VM 2 may be created on a physical host and used as a new secondary VM. In an active-active access scenario in which a primary VM and a secondary VM are deployed to constitute a protection group, when the primary VM is faulty, the secondary VM may be quickly updated to a new primary VM, so that a user does not perceive that the primary VM is faulty or running of the primary VM is interrupted.

However, in the active-active access scenario, because the secondary VM does not need to process a BUM data packet, the BUM data packet does not need to be forwarded to the secondary VM. In addition, because forwarding of the BUM data packet needs to occupy specific network bandwidth, forwarding of the BUM data packet to the secondary VM by a TOR switch results in network bandwidth occupation and a waste of network bandwidth.

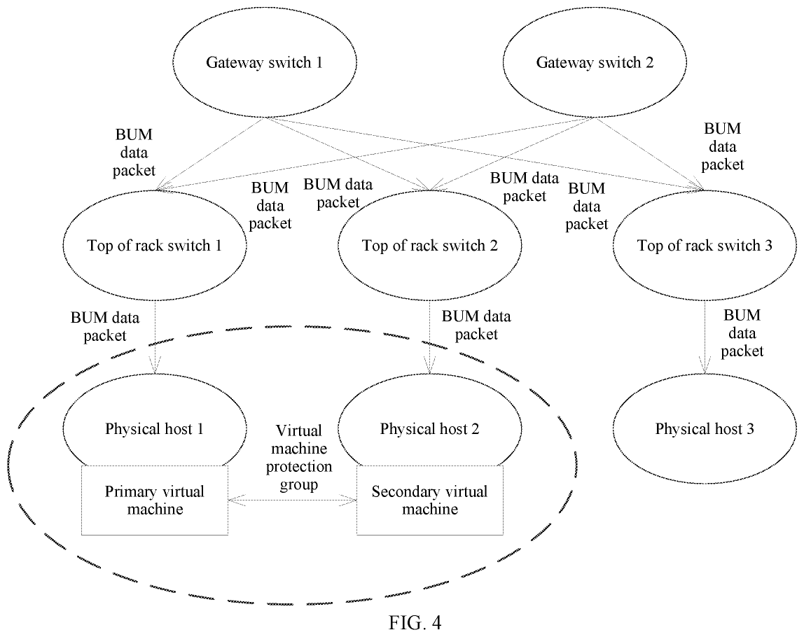

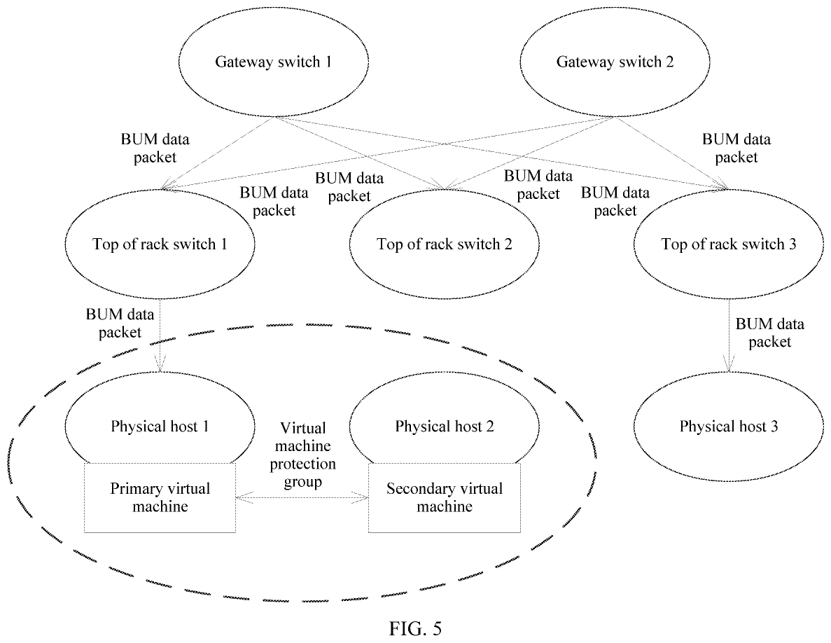

To resolve the foregoing problem, the embodiments of this application provide an information processing method, to prevent a BUM data packet from being forwarded to a secondary VM. FIG. 4 is a schematic diagram of data packet forwarding on an SDN forwarding plane to which the information processing method provided in the embodiments of this application is not applied in the related art. FIG. 5 is a schematic diagram of data packet forwarding on an SDN forwarding plane to which the information processing method provided in the embodiments of this application is applied according to an embodiment of this application. It can be intuitively learned that, in the embodiments of this application, when receiving a BUM data packet, a TOR switch corresponding to a secondary VM does not forward the BUM data packet to the secondary VM, so that network bandwidth required for forwarding the BUM data packet is saved, thereby properly allocating network bandwidth, and avoiding a waste of network resources.

The following starts to describe specific content of the embodiments of this application. For ease of understanding, the following content is described from a perspective of interaction among a network controller, a TOR switch, and a management server.

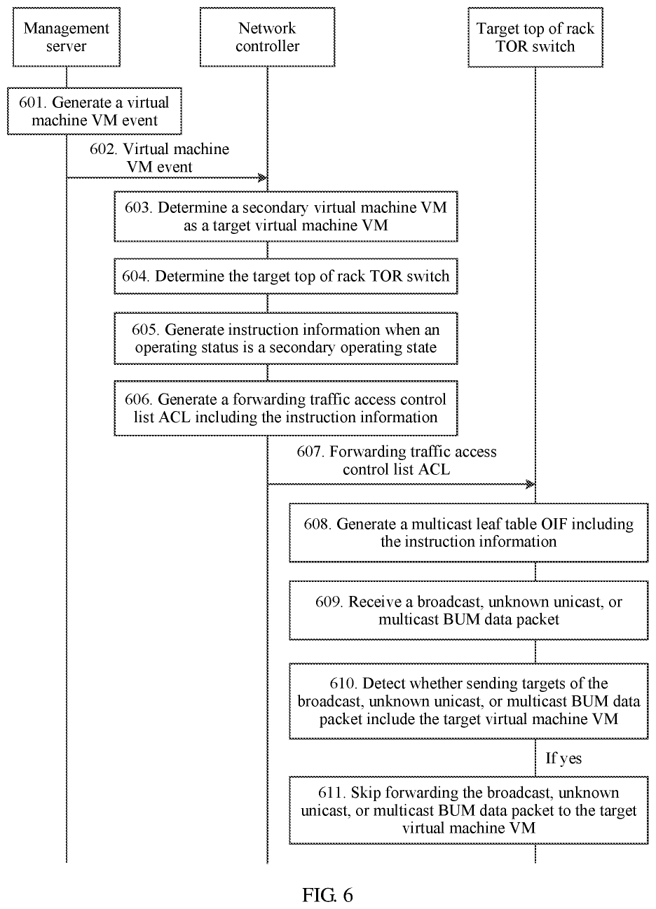

FIG. 6 is a schematic flowchart of an information processing method according to an embodiment of this application. The information processing method provided in this embodiment of this application includes the following steps.

Step 601: A management server generates a VM event.

After creating a primary VM and a secondary VM corresponding to the primary VM on physical hosts based on an active-active access mechanism, the management server may obtain configuration information of the secondary VM, and generate a VM event. The VM event includes the configuration information of the secondary VM. Specifically, the VM event further includes a VM identifier and an operating status of the secondary VM. Each VM has a corresponding VM identifier. The secondary VM may be distinguished from another VM by using the VM identifier of the secondary VM. Certainly, in an embodiment, the configuration information may further include information such as a VM name, a physical host name, a port group, and a media access control (MAC) address. This is not specifically limited herein.

As mentioned herein, the management server creates the secondary VM, where the secondary VM may be understood as a secondary VM newly created based on the active-active access mechanism, or the secondary VM may be understood as another created VM that is obtained due to protection switching of the active-active access mechanism or another update operation. This is not specifically limited herein.

Step 602: The management server sends the VM event to a network controller.

After generating the VM event, the management server may send the VM event to the network controller.

Step 603: The network controller determines the secondary VM as a target VM based on the VM event.

The target VM is the secondary VM corresponding to the VM event.

Step 604: The network controller determines a target TOR switch corresponding to the target VM.

The target TOR switch corresponds to the target VM. Certainly, the target TOR switch may also correspond to another VM.

After receiving the VM event sent by the management server, the network controller may determine, based on the configuration information of the secondary VM that is included in the VM event, the secondary VM as the target VM and the target TOR switch corresponding to the target VM. Specifically, for example, the network controller may find the secondary VM based on port group information in the

VM event, and determine the secondary VM as the target VM, and may further find and determine, based on the physical host name in the VM event, the target TOR switch corresponding to the target VM. Subsequently, the network controller may enable the target VM to access a virtual local area network (VLAN), or the network controller enables the target VM to access a network side of SDN, to implement a state in which the target VM is connected to an external physical network.

In an embodiment, step 603 and step 604 may be performed simultaneously, or step 603 may be performed before step 604, or step 604 may be performed before step 603. This is not specifically limited herein.

Step 605: The network controller generates instruction information when the network controller detects that an operating status of the target VM is a secondary operating state.

The instruction information includes a VM identifier of the target VM, and the instruction information is used to instruct the target TOR switch not to forward a BUM data packet to the target VM.

The operating status of the target VM is the operating status of the secondary VM. The operating status is included in the mentioned VM event, and is used to indicate whether the target VM is in a primary operating state or the secondary operating state. If the network controller detects that the operating status corresponding to the target VM is the primary operating state, the network controller may determine that the target VM is the primary VM. Similarly, if the network controller detects that the operating status corresponding to the target VM is the secondary operating state, the network controller may determine the secondary VM as the target VM.

Referring to the VM event corresponding to the secondary VM, the server may further send a VM event corresponding to the primary VM to the network controller, and the VM event corresponding to the primary VM may include an operating status of the primary VM. The details are not described herein.

In an embodiment, the active-active access mechanism may be specifically a fault tolerance (FT) mechanism. Correspondingly, when the active-active access mechanism is applied, the operating status in the VM event corresponding to the secondary VM or the operating status in the VM event corresponding to the primary VM may be specifically an FT state. Certainly, if another specific protection mechanism for the primary VM and the secondary VM has a same principle as the active-active access mechanism, the protection mechanism may be considered as an active-active access mechanism. This is not specifically limited herein.

In an embodiment, the operating status may be represented by using a number, for example, the secondary operating state is represented by using a number 0, and the primary operating state is represented by using a number 1; or the operating status may be represented in another manner, for example, by using a true value or a non-value, provided that it can be recognized that a VM is in the primary operating state or the secondary operating state. This is not specifically limited herein.

Based on the operating status of the target VM, when the management server notifies, by using the VM event, the network controller to enable the target VM to access the network side of the SDN, the network controller may be triggered to generate the instruction information. Subsequently, the network controller may send the generated instruction information to the target TOR switch immediately, to instruct the target TOR switch not to forward a BUM data packet to the target VM.

In addition, if the operating status of the primary VM and the operating status of the secondary VM are changed subsequently because protection switching, an update operation, or the like is performed on the primary VM and the secondary VM, provided that the management server updates the operating status of the primary VM and the operating status of the secondary VM, an operating status corresponding to a primary VM and an operating status corresponding to a secondary VM on the network controller may be changed conveniently, and the network controller may also conveniently change an operating status corresponding to a primary VM and an operating status corresponding to a secondary VM on the TOR switch. This is more convenient for some embodiments.

When the network controller detects that the operating status in the VM event is the secondary operating state, the network controller may be triggered to generate the instruction information mentioned in this embodiment of the application.

Specifically, the instruction information generated by the network controller includes the VM identifier of the target VM, and may further include a status mark. The status mark corresponds to the target VM, and the status mark includes a secondary identifier used to indicate that the target VM is the secondary VM. The network controller may directly send the status mark to the target TOR switch, or may include the status mark to information related to the target VM that is to be subsequently sent to the target TOR switch. This is not specifically limited herein. Subsequently, the target TOR switch may determine, based on the status mark, the secondary VM as the target VM.

Referring to the status mark corresponding to the secondary VM, the network controller may further send a status mark corresponding to the primary VM to a TOR switch corresponding to the primary VM, and the status mark corresponding to the primary VM may include a primary identifier. The details are not described herein.

Similar to the operating status, in some embodiments, the primary identifier and the secondary identifier in the status marks may be represented by using numbers, for example, the secondary VM is represented by using a number 0, and the primary VM is represented by using a number 1; or the primary identifier and the secondary identifier in the status marks may be represented in another manner, for example, by using non-values or true values, provided that it can be recognized that a VM is the secondary VM. This is not specifically limited herein.

In addition, if the operating status of the primary VM and the operating status of the secondary VM are changed subsequently because protection switching, an update operation, or the like is performed on the primary VM and the secondary VM, provided that the network controller updates the status marks, the primary identifier and the secondary identifier that correspond to the VMs can be changed conveniently. This is more convenient for some embodiments.

Generation of the instruction information and setting of the status mark provide a more specific implementation for the instruction information in this embodiment of this application. This improves feasibility, is relatively simple, is easy to apply and popularize, and has a better effect.

Step 606: The network controller generates a forwarding traffic access control list (ACL).

The ACL corresponds to the target VM, and the ACL includes the instruction information generated in step 605.

Similar to the mentioned status mark, the instruction information may be directly sent to the target TOR switch, or may be included in information related to the target VM that is to be sent to the target TOR switch. For example, the instruction information may be included in the ACL corresponding to the target VM that is to be delivered to the target TOR switch by the network controller. The ACL is used to indicate a data packet forwarding policy related to the corresponding VM to the target TOR switch, and the ACL may further specifically include information such as a MAC address of the target VM and a VLAN identifier of the target VM.

The instruction information is included in the ACL to be delivered to the target TOR switch, so that an existing signaling message is directly used, to prevent signaling interaction between the network controller and the target TOR switch from being more complicated, and further the network controller processes information more conveniently. In addition, after receiving the ACL, the target TOR switch may directly recognize an identity of the target VM when processing data packet forwarding for the target VM based on the ACL. Similar to the network controller, the target TOR switch processes information more conveniently.

Step 607: The network controller sends the ACL generated in step 606 to the target TOR switch.

After generating the ACL including the instruction information, the network controller may send the ACL including the instruction information to the target TOR switch.

In a working process of the network controller, the network controller may further deliver configuration information related to the target VM to the target TOR switch, for example, a related entry required when the target TOR switch forwards a data packet to the corresponding target VM. Specially, the related entry is, for example, a port number, or a correspondence between a VLAN identifier and a virtual extensible local area network network identifier (VXLAN network identifier, VNI). Usually, in a forwarding process, the data packet may be sent to the target TOR switch by using the VNI, and then is sent to the target VM based on configuration information such as the port number and the VLAN identifier after sequentially passing through a physical network interface card, a virtual switch, and a virtual network interface card.

Step 608: The target TOR switch generates an outgoing interface list (outgoing interface list, OIF) based on the ACL.

After receiving the ACL corresponding to the target VM that is sent by the network controller, the target TOR switch may generate, based on the ACL, the OIF corresponding to the target VM. Similar to the ACL, the OIF includes the instruction information, and further includes the information such as the MAC address of the target VM and the VLAN identifier of the target VM.

Step 609: The target TOR switch receives a BUM data packet.

A data packet may be specifically a BUM data packet, and the BUM data packet is a data packet that is not required by the target VM, namely, the secondary VM, in a working process.

The BUM data packet is a data packet that is sent in a broadcast, unknown unicast, or multicast manner.

For example, as shown in FIG. 1 to FIG. 5, the BUM data packet may be sent from a gateway switch.

Step 610: The target TOR switch detects whether sending targets of the BUM data packet include the target VM.

After receiving the BUM data packet, the target TOR switch forwards the

BUM data packet based on the sending targets of the BUM packet. Regardless of whether the BUM data packet is a broadcast data packet, an unknown unicast data packet, or a multicast data packet, the BUM data packet has a corresponding destination address. In this case, in a forwarding process, the target TOR switch may detect whether an address of the target VM in the OIF corresponding to the target VM is included in a destination address of the BUM data packet.

The ACL and the OIF are set, so that a more specific application manner is provided for implementation of the information processing method. This is more practical and is convenient for application and popularization.

Each physical network interface card has a unique corresponding MAC address used to identify a physical address of the physical network interface card. Similarly, a virtual network interface card corresponding to each VM has a unique corresponding VLAN identifier used to identify a virtual address of the virtual network interface card. The target TOR switch stores the MAC address of the target

VM and the VLAN identifier of the target VM, and therefore can quickly determine, only by detecting a destination MAC address of the BUM data packet and a destination VLAN identifier of the BUM data packet, whether the sending targets of the BUM data packet include the connected target VM.

Step 611: The target TOR switch does not forward the BUM data packet to the target VM.

After determining that the sending targets of the BUM data packet include the target VM, and the OIF corresponding to the target VM includes the mentioned instruction information, the target TOR switch does not forward the BUM data packet to the target VM. Specifically, the target TOR switch may continue to forward the

BUM data packet to a VM other than the target VM in the sending targets of the BUM data packet, or may perform an operation, for example, directly discard the BUM data packet, so that storage space occupied by the BUM data packet on the target TOR switch can be released, and storage space of the target TOR switch can be prevented from being occupied.

In the embodiment of this application, when the management server instructs the network controller to enable the target VM to access the network side of the SDN, the network controller sends the instruction information to the target TOR switch corresponding to the target VM, to instruct the target TOR switch to perform traffic optimization, and the target TOR switch may not forward the BUM data packet to the target VM according to the instruction information, where the target VM is the secondary VM created by the management server on the computing side of the SDN for the primary VM, so that the BUM data packet can be diverted to another VM, for example, the primary VM, as shown in FIG. 4 and FIG. 5 that are respectively a schematic diagram of data packet forwarding on an SDN forwarding plane to which the information processing method provided in the embodiment of the application is not applied and a schematic diagram of data packet forwarding on an SDN forwarding plane to which the information processing method provided in the embodiment of the application is applied. Therefore, network bandwidth required for forwarding the BUM data packet to the target VM can be saved, thereby properly allocating network bandwidth, and avoiding a waste of network resources.

Subsequently, when a new virtual machine protection group is constituted because protection switching of the active-active access mechanism or another update operation is triggered and the secondary VM is updated, the management server may send configuration information of a VM related to updating of the secondary VM to the network controller by using a new VM event or in another manner. The network controller may update the instruction information on the original target TOR switch corresponding to the original secondary VM, namely, the original target VM, to update instructing the original target TOR switch not to forward a BUM data packet to the original target VM to instructing the original target TOR switch to forward a BUM data packet to the original target VM, and may further send new instruction information to a new target TOR switch corresponding to a new secondary VM, namely, a new target VM, to constitute an active-active access protection mechanism again to implement new traffic optimization, and instruct the new target TOR switch not to forward a BUM data packet to the new target VM.

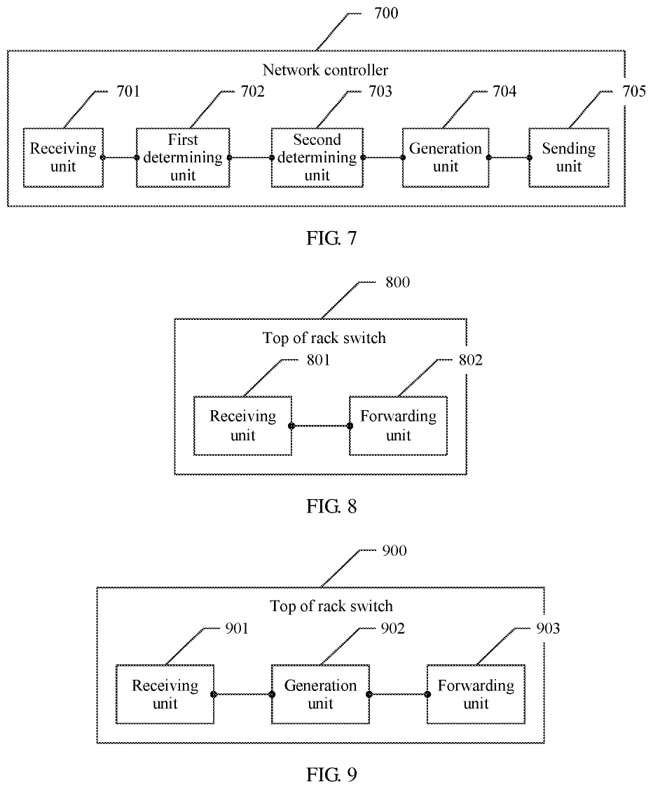

FIG. 7 is a schematic structural diagram of a network controller according to an embodiment of this application. As shown in FIG. 7, the network controller 700 specifically includes: a receiving unit 701, a first determining unit 702, a second determining unit 703, a generation unit 704, and a sending unit 705.

The receiving unit 701 is configured to receive a VM event sent by a management server.

The network controller is disposed in SDN, and the network controller 700 is configured to manage a network side of the SDN. A secondary VM is a VM created by the management server for a primary VM. The management server is configured to manage a computing side of the SDN. A working response result of the primary VM is exchanged with the network side of the SDN, and a working response result of the secondary VM is shielded by the management server and is not exchanged with the network side of the SDN. The secondary VM is configured to take over work of the primary VM when the primary VM is faulty. The VM event is used to instruct the network controller 700 to enable the secondary VM to access the network side of the SDN, and the VM event includes a VM identifier of the secondary VM and an operating status of the secondary VM.

The first determining unit 702 is configured to determine the secondary

VM as a target VM based on the VM event.

The second determining unit 703 is configured to determine a target top of rack TOR switch corresponding to the target VM.

The target TOR switch is disposed on the network side of the SDN.

The generation unit 704 is configured to generate instruction information when the network controller 700 detects that the operating status of the secondary VM is a secondary operating state.

The instruction information includes a VM identifier of the target VM, and the instruction information is used to instruct the target TOR switch not to forward a BUM data packet to the target VM.

The sending unit 705 is configured to send the instruction information to the target TOR switch.

In a possible implementation, the sending unit 705 may be specifically configured to send a forwarding traffic access control list ACL to the target TOR switch. The ACL corresponds to the target VM, and the ACL includes the instruction information.

And, FIG. 8 is a schematic structural diagram of a TOR switch according to an embodiment of this application. As shown in FIG. 8, the TOR switch 800 specifically includes a receiving unit 801 and a forwarding unit 802.

The receiving unit 801 is configured to receive instruction information sent by a network controller. The instruction information includes a VM identifier of a target VM, and the instruction information is used to instruct the TOR switch not to forward a BUM data packet to the target VM. The TOR switch 800 corresponds to the target VM. The target VM is a secondary VM created by a management server for a primary VM. The network controller, the TOR switch 800, and the management server are all disposed in SDN, the management server is configured to manage a computing side of the SDN, and the network controller is configured to manage a network side of the SDN. A working response result of the primary VM is exchanged with the network side of the SDN, and a working response result of the secondary VM is shielded by the management server and is not exchanged with the network side of the SDN. The secondary VM is configured to take over work of the primary VM when the primary VM is faulty.

The forwarding unit 802 is configured to skip forwarding a BUM data packet to the target VM according to the instruction information when the TOR switch 800 receives the BUM data packet.

In a possible implementation, FIG. 9 is another schematic structural diagram of a TOR switch. The TOR switch 900 includes:

a receiving unit 901, specifically configured to receive a forwarding traffic access control list ACL sent by a network controller, where the ACL corresponds to a target VM, and the ACL includes instruction information;

a generation unit 902, configured to generate an OIF based on the ACL, where the OIF corresponds to the target VM, and the OIF includes the instruction information; and a forwarding unit 903, specifically configured to skip forwarding a BUM data packet to the target VM when the TOR switch receives the BUM data packet, the TOR switch detects that a destination address of the BUM data packet includes an address of the target VM in the OIF, and the OIF includes the instruction information.

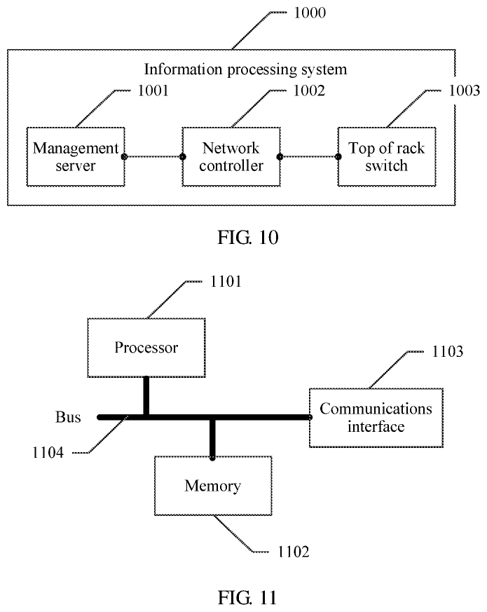

And, FIG. 10 is a schematic structural diagram of an information processing system according to an embodiment of this application. As shown in FIG. 10, the information processing system 1000 includes:

a management server 1001, a network controller 1002, and a target TOR switch 1003. The management server 1001, the network controller 1002, and the target TOR switch 1003 are all disposed in SDN, the management server 1001 is configured to manage a computing side of the SDN, and the network controller 1002 is configured to manage a network side of the SDN.

The management server 1001 is configured to send a VM event to the network controller 1002. The VM event is used to instruct the network controller 1002 to enable a secondary VM to access the network side of the SDN. The secondary VM corresponds to the target TOR switch 1003, and the secondary VM is a VM created by the management server 1001 for a primary VM. A working response result of the primary VM is exchanged with the network side of the SDN, and a working response result of the secondary VM is shielded by the management server 1001 and is not exchanged with the network side of the SDN. The secondary VM is configured to take over work of the primary VM when the primary VM is faulty. The VM event includes a VM identifier of the secondary VM and an operating status of the secondary VM.

The network controller 1002 is configured to determine the secondary VM as a target VM based on the VM event.

The network controller 1002 is configured to determine, based on the VM event, the target TOR switch 1003 corresponding to the target VM.

The network controller 1002 is configured to generate instruction information when the network controller 1002 detects that the operating status is a secondary operating state. The instruction information includes a VM identifier of the target VM, and the instruction information is used to instruct the target TOR switch 1003 not to forward a BUM data packet to the target VM.

The network controller 1002 is configured to send the instruction information to the target TOR switch 1003.

The target TOR switch 1003 is configured to skip forwarding a BUM data packet to the target VM according to the instruction information when receiving the

BUM data packet.

The foregoing content describes the embodiments of this application from a perspective of a modular function entity, and the following describes the embodiments of this application from a perspective of hardware processing.

FIG. 11 is a schematic structural diagram of a network controller according to an embodiment of this application. As shown in FIG. 11, the network controller 1100 may include one or more processors 1101, memories 1102, and communications interfaces 1103.

The processor 1101, the memory 1102, and the communications interface 1103 are interconnected through a bus 1104. The bus 1104 may be classified as an address bus, a data bus, a control bus, or the like. For ease of representation, only one thick line is used to represent the bus in FIG. 11, but this does not mean that there is only one bus or only one type of bus.

The communications interface 1103 may be a wired communications interface, a wireless communications interface, or a combination thereof. The wired communications interface may be, for example, an Ethernet interface. The Ethernet interface may be an optical interface, an electrical interface, or a combination thereof. The wireless communications interface may be a WLAN interface, a cellular network communications interface, a combination thereof, or the like.

The memory 1102 is configured to store the foregoing mentioned identifier of the secondary VM and the operating status corresponding to the secondary VM.

The memory 1102 may include a volatile memory, such as a random-access memory (RAM); or the memory 1102 may include a nonvolatile memory, such as a flash memory, a hard disk drive (HDD), or a solid-state drive (SSD). The memory 1102 may alternatively include a combination of the foregoing types of memories.

The processor 1101 may be a central processing unit (CPU), a network processor (NP), or a combination of a CPU and an NP. The processor 1101 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof.

Optionally, the memory 1102 is further configured to store a program instruction. The processor 1101 invokes the program instruction stored in the memory 1102, to perform the operations of the network controller in the information processing method shown in FIG. 6 in the embodiments of the present application.

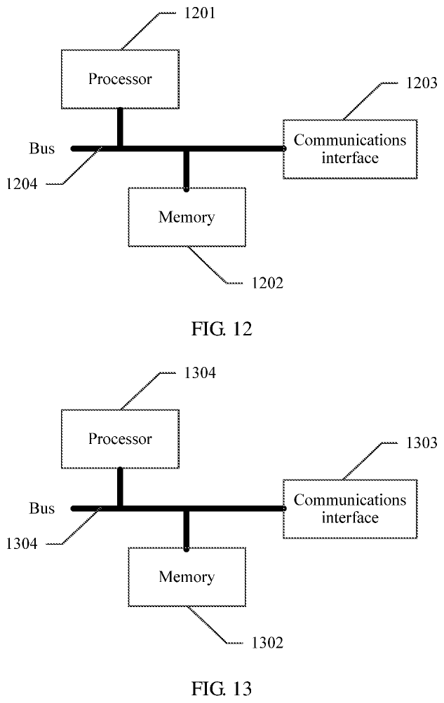

FIG. 12 is a schematic structural diagram of a TOR switch according to an embodiment of this application. As shown in FIG. 12, the TOR switch 1200 may include one or more processors 1201, memories 1202, and communications interfaces 1203.

The processor 1201, the memory 1202, and the communications interface 1203 are interconnected through a bus 1204. The bus 1204 may be classified as an address bus, a data bus, a control bus, or the like. For ease of representation, only one thick line is used to represent the bus in FIG. 12, but this does not mean that there is only one bus or only one type of bus.

The communications interface 1203 may be a wired communications interface, a wireless communications interface, or a combination thereof. The wired communications interface may be, for example, an Ethernet interface. The Ethernet interface may be an optical interface, an electrical interface, or a combination thereof. The wireless communications interface may be a WLAN interface, a cellular network communications interface, a combination thereof, or the like.

The memory 1202 is configured to store the foregoing mentioned instruction information.

The memory 1202 may include a volatile memory, such as a RAM; or the memory 1202 may include a nonvolatile memory, such as a flash memory, an HDD, or an SSD. The memory 1202 may alternatively include a combination of the foregoing types of memories.

The processor 1201 may be a CPU, an NP, or a combination of a CPU and an NP. The processor 1201 may further include a hardware chip. The hardware chip may be an ASIC, a PLD, or a combination thereof. The PLD may be a CPLD, an FPGA, GAL, or any combination thereof.

Optionally, the memory 1202 is further configured to store a program instruction. The processor 1201 invokes the program instruction stored in the memory 1202, to perform the operations of the TOR switch in the information processing method shown in FIG. 6 in the embodiments of the present application.

FIG. 13 is a schematic structural diagram of a management server according to an embodiment of this application. As shown in FIG. 13, the management server 1300 may include one or more processors 1301, memories 1302, and communications interfaces 1303.

The processor 1301, the memory 1302, and the communications interface 1303 are interconnected through a bus 1304. The bus 1304 may be classified as an address bus, a data bus, a control bus, or the like. For ease of representation, only one thick line is used to represent the bus in FIG. 13, but this does not mean that there is only one bus or only one type of bus.

The communications interface 1303 may be a wired communications interface, a wireless communications interface, or a combination thereof. The wired communications interface may be, for example, an Ethernet interface. The Ethernet interface may be an optical interface, an electrical interface, or a combination thereof. The wireless communications interface may be a WLAN interface, a cellular network communications interface, a combination thereof, or the like.

The memory 1302 may include a volatile memory, such as a RAM; or the memory 1302 may include a nonvolatile memory, such as a flash memory, an HDD, or an SSD. The memory 1302 may alternatively include a combination of the foregoing types of memories.

The processor 1301 may be a CPU, an NP, or a combination of a CPU and an NP. The processor 1301 may further include a hardware chip. The hardware chip may be an ASIC, a PLD, or a combination thereof. The PLD may be a CPLD, an FPGA, GAL, or any combination thereof.

Optionally, the memory 1302 is further configured to store a program instruction. The processor 1301 invokes the program instruction stored in the memory 1302, to perform the operations of the management server in the information processing method shown in FIG. 6 in the embodiments of the present application.

This application further provides a computer-readable storage medium. The computer-readable storage medium includes an instruction, and when the instruction runs on a network controller, the network controller is enabled to perform the method performed by the network controller in the method embodiment corresponding to FIG. 6.

This application further provides a computer-readable storage medium. The computer-readable storage medium includes an instruction, and when the instruction runs on a TOR switch, the TOR switch is enabled to perform the method performed by the TOR switch in the method embodiment corresponding to FIG. 6.

This application further provides a computer program product. The computer program product includes a computer software instruction, and when the computer software instruction runs on a network controller, the network controller is enabled to perform the method performed by the network controller in the method embodiment corresponding to FIG. 6.

This application further provides a computer program product. The computer program product includes a computer software instruction, and when the computer software instruction runs on a TOR switch, the TOR switch is enabled to perform the method performed by the TOR switch in the method embodiment corresponding to FIG. 6.

For convenient and brief description, for specific working processes of the foregoing described information processing system, network controller, TOR switch, and corresponding units thereof, reference may be made to the corresponding processes in the method embodiment corresponding to FIG. 6. Details are not described herein again.

In the several embodiments provided in this application, the disclosed information processing system, network controller, TOR switch, corresponding units thereof, and information processing method may be implemented in another manner. For example, the described apparatus embodiments are merely examples. For example, the unit division is merely logical function division and may be other division in some embodiments. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of the embodiments.

In addition, the function units in the embodiments of this application may be integrated into one processing unit, or each of the units may exist alone physically, or two or more units may be integrated into one unit. The integrated unit may be implemented in a form of hardware, or may be implemented in a form of a software function unit.

When the integrated unit is implemented in the form of the software function unit and sold or used as an independent product, the integrated unit may be stored in a computer-readable storage medium. Based on such an understanding, the technical solutions of this application essentially, or the part contributing to the related art, or all or some of the technical solutions may be implemented in a form of a software product. The computer software product is stored in a storage medium and includes several instructions for instructing a computer device (which may be a personal computer, a server, a network device, or the like) to perform all or some of the steps of the method described in the embodiments of this application. The storage medium includes any medium that can store program code, such as a USB flash drive, a removable hard disk, a read-only memory (ROM), a RAM, a magnetic disk, or an optical disc.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions recorded in the foregoing embodiments or make equivalent replacements to some technical features thereof, without departing from the scope of the technical solutions of the embodiments of this application.

What is claimed is:

1. A method, comprising:
receiving, by a network controller, a virtual machine (VM) event, wherein the VM event comprises a VM identifier and an operating status of a VM corresponding to the VM identifier;
determining, by the network controller, the VM as a target VM when the VM is a secondary VM;
determining, by the network controller, a top of rack (TOR) switch corresponding to the target VM;
generating, by the network controller, instruction information when an operating status of the target VM is a secondary operating state, wherein the instruction information comprises a VM identifier of the target VM, and the instruction information is used to instruct the TOR switch not to forward a broadcast, unknown unicast, or multicast (BUM) data packet to the target VM; and
sending, by the network controller, the instruction information to the TOR switch.

2. The method according to claim 1, wherein the sending, by the network controller, the instruction information to the TOR switch comprises:
sending, by the network controller, a forwarding traffic access control list to the TOR switch, wherein the forwarding traffic access control list corresponds to the target VM, and the forwarding traffic access control list comprises the instruction information.

3. The method according to claim 1, wherein the VM event further comprises one or more of: a name of the secondary VM, a physical host name of the secondary VM, a port group of the secondary VM, and a media access control (MAC) address of the secondary VM.

4. The method according to claim 1, wherein the operating status of the target VM is a fault tolerance (FT) state.

5. The method according to claim 1, wherein the operating status of the target VM is represented by using a number

6. The method according to claim 1, wherein the secondary operating state is represented by using a number 0, and a primary operating state is represented by using a number 1.

7. The method according to claim 1, wherein the operating status of the target VM is represented by using a true value or a non-value.

8. The method according to claim 1, wherein the network controller and the TOR switch are in a same network.

9. The method according to claim 8, wherein the network is software-defined networking (SDN).

10. The method according to claim 1, wherein the secondary VM is a backup VM of a primary VM.

11. The method according to claim 10, wherein the primary VM and the secondary VM are on different physical hosts.

12. A method, comprising:
receiving, by a top of rack (TOR) switch, instruction information, wherein the instruction information comprises a VM identifier of a target virtual machine (VM), and the instruction information is used to instruct the TOR switch not to forward a broadcast, unknown unicast, or multicast (BUM) data packet to the target VM; and
skipping, by the TOR switch, forwarding a received BUM data packet to the target VM according to the instruction information when the TOR switch receives the BUM data packet and the received BUM data packet needs to be sent to the secondary VM.

13. The method according to claim 12, wherein the receiving, by a TOR switch, instruction information comprises: receiving, by the TOR switch, a forwarding traffic access control list (ACL), wherein the ACL comprises the instruction information;
the method further comprises: generating, by the TOR switch, an outgoing interface list (OIF) based on the ACL, wherein the OIF comprises the instruction information; and
the skipping, by the TOR switch, forwarding a received BUM data packet to the target VM according to the instruction information when the TOR switch receives the BUM data packet and the received BUM data packet needs to be sent to the secondary VM comprises: skipping, by the TOR switch, forwarding the BUM data packet to the target VM when the TOR switch receives the BUM data packet and the TOR switch detects that a destination address of the BUM data packet comprises an address of the target VM in the OIF.

14. The method according to claim 12, wherein the instruction information is sent by a network controller to the TOR switch.

15. The method according to claim 14, wherein the network controller and the TOR switch are in a same network.

16. The method according to claim 15, wherein the network is software-defined networking (SDN).

17. A network controller, comprising a processor and a communications interface, wherein the communications interface is configured to receive a virtual machine (VM) event, wherein the VM event comprises a VM identifier and an operating status of a VM corresponding to the VM identifier;
the processor is configured to:
determine the VM as a target VM based on the VM event when determining that the VM is a secondary VM;
determine a top of rack (TOR) switch corresponding to the target VM; and
generate instruction information when detecting that the operating status of the secondary VM is a secondary operating state, wherein the instruction information comprises a VM identifier of the target VM, and the instruction information is used to instruct the TOR switch not to forward a broadcast, unknown unicast, or multicast BUM data packet to the target VM; and
the communications interface is further configured to send the instruction information to the TOR switch.

18. The network controller according to claim 17, wherein the VM event further comprises one or more of: a name of the secondary VM, a physical host name of the secondary VM, a port group of the secondary VM, and a media access control (MAC) address of the secondary VM.

19. The network controller according to claim 17, wherein an operating status of the target VM is a fault tolerance (FT) state.

20. The network controller according to claim 17, wherein an operating status of the target VM is represented by using a number, or an operating status of the target VM is represented by using a true value or a non-value.
